(19) United States
(12) Patent Application Publication
(10) Pub. No.: US 2016/0125410 A1
(43) Pub. Date: May 5, 2016

(54) System and Method for Detecting and Preventing Social Engineering-Type Attacks Against Users

(71) Applicant: Michael Boodaei, Givatayim (IL)

(72) Inventor: Michael Boodaei, Givatayim (IL)

(21) Appl. No.: 14/925,216

(22) Filed: Oct. 28, 2015

Related U.S. Application Data
(60) Provisional application No. 62/069,869, filed on Oct. 29, 2014.

(51) Int. Cl. G06Q 20/40; G06Q 50/00

(52) U.S. Cl. CPC G06Q 20/405; G06Q 50/01; G06Q 20/401

(57) ABSTRACT

The invention relates to system for validating a transaction in an institution and ensuring that said transaction has not been exploited by use of social-engineering, which comprises: (A). in an institution server: (a) a validation engine which is configured to: (a.1)receiving a request message for the performance of a transaction validation against a possibility of social-engineering type manipulation, said request comprises parameters of said transaction; (a.2) based on a set of predefined rules and on a storage of predefined template messages, selecting a message template from said storage, filling fields of the message with specific data, and sending an inquiry message to an application of said institution within a customer device; and (a.3) receiving a response message from said application, and either repeating formulation and sending of an additional message to said application, or concluding the request; (B.) in a customer device: (b) an application and a user interface for: (b.1) receiving said inquiry message, and displaying the same to the customer; (b.2) receiving a customer response to said inquiry message, formulating a response message, and forwarding to said institution server; wherein said rules and said template messages are particularly designed to allow formulation of messages by said validation engine that inquire the customer with respect to social-engineering types of issues.

### CROSS REFERENCE TO RELATED APPLICATIONS

This application claims the benefit of U.S. Provisional Application No. 62/069,869, filed Oct. 29, 2014, which is incorporated by reference in its entirety.

### FIELD OF INVENTION

The invention relates in general to the field of validation of an electronic transaction or another operation within a computerized environment, such as the e-commerce environment.

### BACKGROUND OF THE INVENTION

Enterprises such as financial institutions, healthcare institutions, and retailers often require their users to confirm specific security-related operations such as transactions, changes to billing addresses, requests for password resets, and abnormal access attempts. Typically, the institutions validate such operations (hereinafter, both “operations” and “transactions” will be referred to herein by the term “transactions”) via an alternative channel which is separate from the channel through which said transaction was allegedly performed by the client. For example, if a transaction was performed via a bank mobile application in a mobile device, or via the bank website, the validation process is typically performed by sending an SMS to the user's mobile phone, asking him to confirm by a return message that he himself performed the transaction. In relatively rare cases, a bank clerk may directly call the client to confirm the validity of the transaction.

During this confirmation process the user is usually presented with the details of the transaction and is requested to confirm and authenticate the transaction. The different channel and procedure over which the confirmation and authentication process typically takes place may use a card and reader device, a mobile application, or a callback to the user's landline phone. The purpose of this process is to block attacks in which an attacker compromises the user's endpoint device or the user's login credentials and performs a certain transaction on behalf of the user. The confirmation and authentication process could stop the attack if the real user who gets the request for confirmation doesn't confirm or authenticate an event that he or she did not initiate.

Over the years attackers have found ways around this procedure using social engineering techniques. Google defines “social engineering” as “. . . a non-technical method of intrusion hackers use that relies heavily on human interaction and often involves tricking people into breaking normal security procedures. It is one of the greatest threats that organizations today encounter”. A good example for that is when a bank asks a customer to confirm and authenticate a transaction using a card and reader device or a mobile application. The following is an example for such an attack: First, the hacker compromises the customer's online bank account by stealing login credentials using a phishing attack or placing malware on the customer's computer. Next, the hacker who now has access to the customer's online account initiates a transaction on behalf of the customer. However, to complete this fraudulent transaction, the hacker now needs the customer to authenticate and confirm the transaction using card and reader or a mobile device to which the hacker has no access. To achieve this target, the hacker may use one of various social engineering techniques that are available to him over the phone. For example, the hacker may call the customer and pretend to be a bank or a law enforcement representative. The hacker starts the conversation by revealing private information relating to the customer's account such as the latest activity in the account, or the account balance. As the hacker has previously gained access to the customer's online account, the hacker in fact gained access to this information as well. This process usually convinces the customer that the hacker is a bank or law enforcement representative, as only the bank knows that much about the customer's account. Once trust is established between the hacker and the customer, the hacker convinces the customer to approve a fraudulent transaction. There are various ways of doing that, and they all depend on the hacker's social engineering creativity. For example, the hacker may tell the customer that this is an educational guidance about some changes to the banking system, and during this lesson the customer is requested to run an allegedly non-real transaction, only in reality this transaction is very real. In another example, a message or clerk tells the customer that there is a security breach in his account, and for the customer's own safety the money in the account needs to be transferred to a new account where it will be kept safe. The new account is in fact the fraudulent account which the hacker has prepared in advance.

It is therefore an object of the present invention to provide a system for preventing social engineering based attacks;

It is another object of the present invention to provide a system which authenticates and validates customers transactions in the e-commerce environment;

Other objects and advantages of the invention will become apparent as the description proceeds.

### SUMMARY OF THE INVENTION

The invention relates to system for validating a transaction in an institution and ensuring that said transaction has not been exploited by use of social-engineering, which comprises: (A). in an institution server: (a) a validation engine which is configured to: (a.1) receiving a request message for the performance of a transaction validation against a possibility of social-engineering type manipulation, said request comprises parameters of said transaction; (a.2) based on a set of predefined rules and on a storage of predefined template messages, selecting a message template from said storage, filling fields of the message with specific data, and sending an inquiry message to an application of said institution within a customer device; and (a.3) receiving a response message from said application, and either repeating formulation and sending of an additional message to said application, or concluding the request; (B.) in a customer device: (b) an application and a user interface for: (b.1) receiving said inquiry message, and displaying the same to the customer; (b.2) receiving a customer response to said inquiry message, formulating a response message, and forwarding to said institution server; wherein said rules and said template messages are particularly designed to allow formulation of messages by said validation engine that inquire the customer with respect to social-engineering types of issues.

In an embodiment of the invention, the system further comprises encryption and decryption units in both said server and application, for communicating messages in encrypted form between the server and the application.

In an embodiment of the invention, the evaluation of the response message and the decision whether to issue an additional inquiry message, or otherwise to conclude the validation session are performed at the server.

In an embodiment of the invention, the response message is forwarded from the server to the issuing division of the request message, and the evaluation of the response message and the decision whether to issue an additional message or to conclude the session are performed at said request issuing division.

In an embodiment of the invention, said inquiry message further comprises authentication fields, and wherein data within said authentication fields cause activation of an authenticator within sais customer device, said authenticator in turn extracts authentication related data from hardware units within the device, or it receives authentication related inputs from the customer.

In an embodiment of the invention, said authentication related data or inputs, respectively, as extracted or received from the customer are evaluated either by said application, or forwarded within the response message to the server, for evaluation at said server.

### BRIEF DESCRIPTION OF THE DRAWINGS

In the drawings:

FIG. 1 shows a typical prior art system for the interaction between a mobile application and a server of an institution; and

FIG. 2 describes in block diagram form a system for detecting and eliminating social-engineering threats, according to an embodiment of the invention.

### DETAILED DESCRIPTION OF PREFERRED EMBODIMENTS OF THE INVENTION

The present invention discloses a system for eliminating social engineering types of threats in an e-commerce environment. As noted above, the prior art procedure for validating transactions that have allegedly been performed by a customer involves sending a message to the customer over an alternative channel which is separate from the channel in which the transaction was performed, requesting the customer to either confirm the transaction or to reject it. As also noted, such a prior art procedure does not eliminate various social-engineering techniques that are applied by attackers (several of those techniques have been elaborated above).

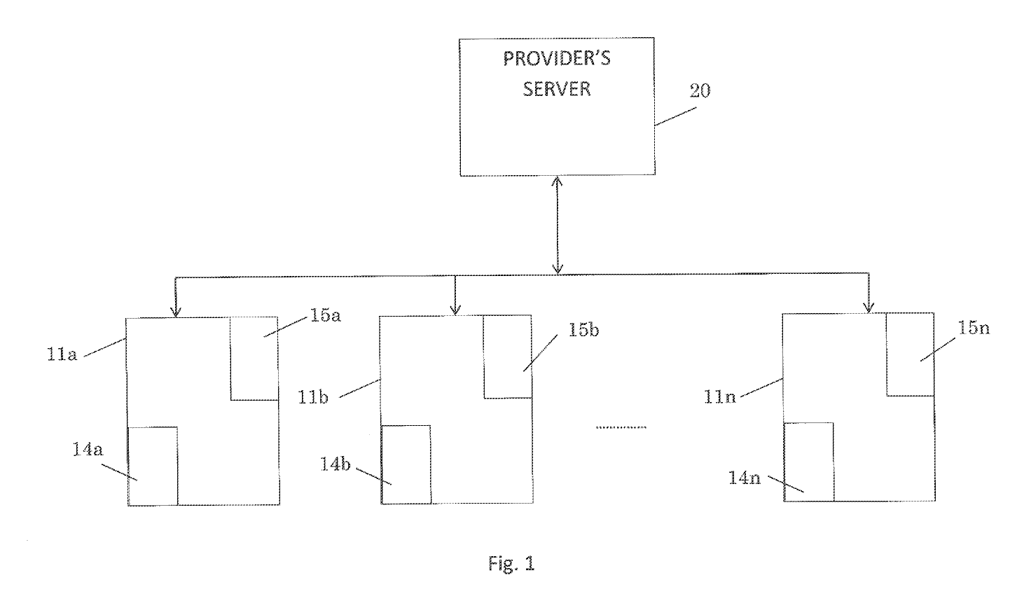

FIG. 1 shows a typical prior art situation where a provider (such as a financial institution, an e-commerce seller or service provider, etc.) distributes (for example, via an App Store) an application 15, a copy of which is installed within each customer mobile device 11 (such as smart phone). For example, a bank typically distributes such an application to his customers for installation within their mobile devices, respectively. Such a bank application enables the respective customer to access the bank server 20 by means of application 15, to download or view information relating to his bank account, to submit orders to the bank, to view his credit card status, to perform transactions, etc. A huge number of such applications already exist in the market. As will be elaborated, the invention utilizes such an application for the purpose of validating a given transaction.

As will be described in more details, the application which is distributed by the institution (such as a bank) and is installed at the customer's smart phone for performing various tasks is also used by the invention to eliminate various kinds of social-engineering-related threats.

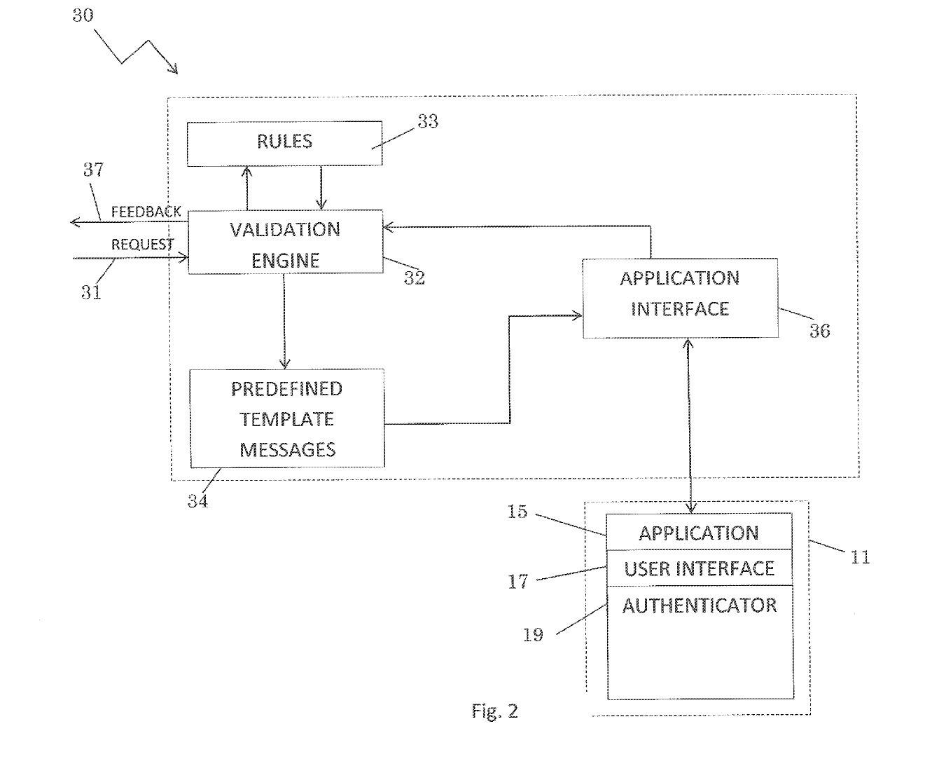

FIG. 2 describes a general structure of a system 30 for eliminating social engineering-types of threats, according to an embodiment of the present invention. Upon a necessity to validate a transaction, a division of the institution (for example, a checking account division of a bank) sends a request for validation 31 (hereinafter also referred to as the “request”) to the server 20 to carry out a transaction social-engineering-related validation procedure against the customer. The division attaches within the request specific details of the transaction that was allegedly performed by the client, and preferably also attribute parameters such as priority, sensitivity, risk level, etc. The request is forwarded to a validation engine 32 within server 20. The validation engine 20 operates based on a predefined set of rules 33, that define for the validation engine how to react to various contents of the request for validation, or to answers from the customer to inquiry messages that are sent to him via the institution's application. Having the content of the request, and based on the set of rules 33, the validation engine selects a message from the storage of predefined template messages 34 a most suitable message. The selected message is in fact a template message, to which the validation engine adds parameters that are specific to the received request 31 to form an inquiry message. Moreover, the message, as formulated by the validation engine 32, may include various authentication elements for authenticating the customer and his device, as will be elaborated hereinafter. Then, the inquiry message is transferred to application interface 36, which in turn transmits the message to the application 15 within the mobile device 11. As noted, the mobile application 15 is an application which is distributed by the institution, and is typically designed allows the customer to interact with the institution's server 20 for various purposes. The invention utilizes the application 15 to detect and eliminate social engineering-types of attacks. As will be discussed in more details, the application 15 displays the message to the user via a user interface 17. The customer, in turn, responds to the inquiry message by answering one or more questions that are included within the message, and are particularly related to the detection and elimination of social engineering types of threats. The response of the customer to the inquiry message is sent back to the validation engine 32 (within server 20) via the application interface 36. The validation engine 32 conveys the user's response message as feedback 37 to the request initiating division. The request initiating division, in turn, may find the customer response as being satisfactory to conclude the session, or otherwise it may send an additional request to the validation engine 32. This procedure may continue several times (i.e., several request messages may be issued), until a conclusion is reached.

It should be noted that the evaluation of each the user's response messages may be performed either within the server 20, or within the request message issuing division. Therefore, the decision whether to issue an additional request message or to conclude the session may also take place in either one of said units, respectively.

As noted, while the prior art systems confirm and validate a transaction per se by sending a request for confirmation message over an alternative channel to the customer, to which the customer is required to provide merely a yes/no confirmation answer of the transaction itself, the system of the invention issues messages that are specifically targeted to eliminate social-engineering attacks, and their content include a broader scope than just confirming the transaction itself Moreover, the system of the invention utilizes for this purpose the application 15, which may be the same channel on which a part of the social-engineering manipulation was illegally performed. Therefore, an inquiry message may include a question such as:
a. “Have you received a phone call today allegedly from a bank representative?”
b. If the answer to the previous question is positive, a next inquiry message may be: “were you requested to participate in a learning session?”
c. If the answer to the previous question is positive, a next inquiry message may be: “were you requested to perform a “test” transfer of money from your account to another account?”
d. Additional messages may be formulated, according to situations and experience with respect to social engineering attacks that may develop, and based on the specific customer and issues that need to be validated.

The inquiry message to the user also includes authentication elements that are used for various authentication purposes at the user device 11, i.e., to provide additional feedback to the server with respect to the authenticity of the user and his device. For example, such validation elements may activate one or more of the following extraction or customer inputting units within an authenticator module 19 at device 11 and for conveying respective data to the server 20:
a. A card and a respective reader;
b. A camera for transferring an image of the customer for a face recognition;
c. A GPS for verifying the location of the user within an expected geographical area;
d. A fingerprint module for extracting the fingerprints of the user;
e. A voice recognition module;
f. Etc.

It should be noted that expected data with respect to one or more of the above authentication elements may be sent within one or more inquiry messages from the server 20 to the device 11, and upon real time extraction by the authenticator of one or more of the above elements, the verification can be performed internally within the device 11 by respective verification modules that are provided at application 15. Alternatively, the data as accumulated by the authenticator may be sent to the server 20, and the authentication may be performed either at server 20, or at the request issuing division.

In an embodiment of the invention, the device 11 may be a stationary computer, and the application may be adapted to operate on a stationary computer, respectively.

### EXAMPLE

The following is a non-limiting example:
1. Any division within an enterprise (such as a bank) may send a request to the validation engine 32. Each request comprises one or more fields such as: message type, recipient's username, subject, priority, sensitivity, risk level, expected location area of device 11, time of request, etc. A few fields are mandatory (such as username) and the rest of the fields are optional and can be decided by the validation engine based of predefined rules 33.
2. The validation engine 32 formulates an inquiry message based on the content of the request 31, on predefined template messages 34, and on the rules 33. For example: if a field “Event-Type” within the request 31 has a value of “phone number change” and a field “Risk-Level” has the value of “high”, then the processing by the validation engine 32 may result in selection of template message number 23 from the predefined template messages storage 34. Each message relates to one of the following types:
   a. A request for user authentication by use of one specific module by the authenticator 19, such as fingerprint, voice recognition, face recognition, password, etc.;
   b. A request for information from the user's device 11 by use of one specific module from the authenticator, such as GPS location, operating system version, connection type, etc.;
   c. A question presented to the user via the user interface 17 to which the user must reply;
   d. An informative and inquiry message presented to the user via the user interface 17, to which the user has to respond;
3. The application 15, (which as noted may be a mobile application, a web application, or any other client technology) establishes communication with server 20. Validation engine 32 sends the respective inquiry message, as formulated and then encrypted, to device 11.
4. Application 15 within device 11 receives the inquiry message. Based on the type of the message, the application 15 communicates with the customer (via the user interface 17) or with the authenticator 19, respectively to either:
   a. Activate a respective authenticator module (not shown in FIG. 2) which runs and gets a respective authentication result (success or failure—assuming in this example that the authentication process is performed locally within the device 11).
   b. Access the device 11 to retrieve additional information, such as, GPS location, operating system version, or connection type;
   c. Present an inquiry question to the customer via the user interface 17, and wait for the user reply;
   d. Present an informative message to the customer and ask the customer to respond;
5. The results are collected by the device 11, and placed in respective fields of a response message. The structure of the response message may be similar to the structure of the request as sent to server 20 from the request initiating division. The device 11 signs the response message with the customer's private key.
6. The response message is sent back to the server 20, and the application 15 waits to see whether server 20 sends an additional message or concludes the process;
7. Server 20 verifies the response message by use of the user's public key, and pushes the response message to the validation engine for verification The verification may involve consultation with one or more databases that are located outside of the server 20, such as in the request issuing division, or another division. Alternatively, the response message may be completely conveyed to the request issuing division, and the verification process may be performed there.
8. The verification may result in the issue of an additional request message, and in that case the process may repeat until the validation engine or the request issuing division concludes that there is no need for additional social engineering-related information from the customer;
9. Upon reaching a conclusion (usually approve or deny), server 20 informs the customer in a similar manner as described that the process has been completed. If necessary, the user may also be informed on the results of the validation process.

1. A system for validating a transaction in an institution and ensuring that said transaction has not been exploited by use of social-engineering, which comprises:
A. in an institution server:
(a) a validation engine which is configured to:
receiving a request message for the performance of a transaction validation against a possibility of social-engineering type manipulation, said request comprises parameters of said transaction;
based on a set of predefined rules and on a storage of predefined template messages, selecting a message template from said storage, filling fields of the message with specific data, and sending an inquiry message to an application of said institution within a customer device; and
receiving a response message from said application, and either repeating formulation and sending of an additional message to said application, or concluding the request;
B. in a customer device:
(b) an application and a user interface for:
receiving said inquiry message, and displaying the same to the customer;
receiving a customer response to said inquiry message, formulating a response message, and forwarding to said institution server;
wherein said rules and said template messages are particularly designed to allow formulation of messages by said validation engine that inquire the customer with respect to social-engineering types of issues.

2. System according to claim 1, which further comprises encryption and decryption units in both said server and application, for communicating messages in encrypted form between the server and the application.

3. System according to claim 1, wherein the evaluation of the response message and the decision whether to issue an additional inquiry message, or otherwise to conclude the validation session are performed at the server.

4. System according to claim 1, wherein the response message is forwarded from the server to the issuing division of the request message, and the evaluation of the response message and the decision whether to issue an additional message or to conclude the session are performed at said request issuing division.

5. System according to claim 1 wherein said inquiry message further comprises authentication fields, and wherein data within said authentication fields cause activation of an authenticator within sais customer device, said authenticator in turn extracts authentication related data from hardware units within the device, or it receives authentication related inputs from the customer.

6. System according to claim 1 wherein said authentication related data or inputs, respectively, as extracted or received from the customer are evaluated either by said application, or forwarded within the response message to the server, for evaluation at said server.
